(19) United States
(12) Patent Application Publication
(10) Pub. No.: US 2022/0247867 A1
(43) Pub. Date: Aug. 4, 2022

(54) SYSTEM AND METHOD FOR MANAGING CONFERENCE DOORPLATE AND CONFERENCE DOORPLATE

(71) Applicant: BOE Technology Group Co., Ltd., Beijing (CN)

(72) Inventors: Shijie CAO, Beijing (CN); Yingjie LI, Beijing (CN)

(21) Appl. No.: 17/614,349

(22) PCT Filed: Jan. 19, 2021
(86) PCT No.: PCT/CN2021/072757

§ 371 Date: Nov. 25, 2021

(30) Foreign Application Priority Data
Jan. 21, 2020 (CN) 202010069252.5

(51) Int. Cl. H04M 3/56; H04L 12/18; G09G 3/34

(52) U.S. Cl. CPC H04M 3/565; G09G 3/344; H04L 12/1822; H04L 12/1818

(57) ABSTRACT

A system and method for managing a conference doorplate and a conference doorplate (12) are provided. The system includes a server (11) and a conference doorplate (12), the conference doorplate including a display screen, wherein the server (11) is configured to regularly acquire conference reservation information of a target conference room; generate to-be-displayed information based on the conference reservation information; send the to-be-displayed information; and send a task update instruction of the target conference room after receiving the task update instruction, wherein the task update instruction is configured to update the to-be-displayed information; the conference doorplate (12) is configured to receive the to-be-displayed information and display the to-be-displayed information through the screen, and the conference doorplate (12) is further configured to receive the task update instruction and update the to-be-displayed information based on the task update instruction.

### CROSS-REFERENCE TO RELATED APPLICATION

This application is a US national phase application based on PCT/CN2021/072757, filed on Jan. 19, 2021, which claims priority to Chinese Patent Application No. 202010069252.5, filed on Jan. 21, 2020 and entitled “SYSTEM FOR MANAGING CONFERENCE DOORPLATE AND ELECTRONIC INK CONFERENCE DOORPLATE,” the disclosure of which is herein incorporated by reference in its entirety.

### TECHNICAL FIELD

The present disclosure relates to the field of information management technologies, and specifically to a system and method for managing a conference doorplate and a conference doorplate.

### BACKGROUND

With the proposal of concepts such as smart office, paperless office, and environment-friendly office, many conference rooms are currently equipped with conference doorplates to display their reservation status.

### SUMMARY

Embodiments of the present disclosure provide a system and method for managing a conference doorplate and a conference doorplate.

According to an aspect of embodiments of the present disclosure, a system for managing a conference doorplate is provided. The system for managing the conference doorplate includes a server and a conference doorplate, the conference doorplate including a display screen; wherein

the server is configured to regularly acquire conference reservation information for a target conference room, generate to-be-displayed information based on the conference reservation information; send the to-be-displayed information, and send a task update instruction for the target conference room after receiving the task update instruction, wherein the task update instruction is configured to update the to-be-displayed information;

the conference doorplate is configured to receive the to-be-displayed information and display the to-be-displayed information via the screen; and

the conference doorplate is further configured to receive the task update instruction and update the to-be-displayed information based on the task update instruction.

Optionally, the system for managing the conference doorplate includes a wireless refresh device, wherein the wireless refresh device is connected to the server and a signal range of the wireless refresh device covers the conference doorplate;

the server is further configured to send a target doorplate identifier to the wireless refresh device; and

the wireless refresh device is configured to receive the to-be-displayed information and the target doorplate identifier that are sent by the server; send the to-be-displayed information based on the target doorplate identifier, and send a task update instruction after receiving the task update instruction sent by the server.

Optionally, the conference doorplate is configured to receive the to-be-displayed information sent by the wireless refresh device; display the to-be-displayed information, and update the to-be-displayed information after receiving the task update instruction sent by the wireless refresh device.

Optionally, the system for managing the conference doorplate further includes a conference management client; wherein the conference management client is connected to the server;

the conference management client is configured to perform at least one of the following: binding the target conference room to the target doorplate identifier of the conference doorplate, updating doorplate information of the conference doorplate; searching for the conference doorplate, and setting a display template of the conference doorplate; and

the doorplate information includes at least one of the target doorplate identifier and a doorplate size.

Optionally, the display screen of the conference doorplate displays a conference reservation code, wherein the conference reservation code includes at least one of a two-dimensional code and a conference room electronic tag; and

in the case that the conference reservation code is configured to jump to a first conference reservation page of the system for managing the conference doorplate, the server is further configured to receive a conference reservation message for the target conference room based on the conference reservation code.

Optionally, the display screen of the conference doorplate displays a conference reservation code, wherein the conference reservation code includes at least one of a two-dimensional code and a conference room electronic tag; and

in the case that the conference reservation code is configured to jump to a second conference reservation page of a third-party conference reservation system, the server is further configured to receive a conference reservation message sent by the third-party conference reservation system, after the third-party conference reservation system receives a reservation instruction for the target conference room in the second conference reservation page based on the conference reservation code and generates the conference reservation message based on the reservation instruction of the target conference room.

Optionally, the server is further configured to generate first display information based on the conference reservation information and a first preset type display template and determine the first display information as the to-be-displayed information in the case that the conference reservation information has content; and

generate second display information based on a second preset type display template and determine the second display information as the to-be-displayed information in the case that the conference reservation information does not have content.

Optionally, in the case that the conference reservation information has the content:

the first display information includes reserved information and unreserved information that correspond to the target conference room, or the first display information includes reserved information corresponding to the target conference room, wherein

the reserved information includes at least one of the following: a reserved period, a booking person, a piece of contact information, and a reserved state; and

the unreserved information includes an idle period and an idle state.

Optionally, in the case that the first display information includes the reserved information and unreserved information that correspond to the target conference room, the server is further configured to determine a total information amount of the reserved information and the unreserved information in the first display information; and

the server is further configured to send first target display information including a preset amount of reservation information at a first predetermined moment in the case that the total information amount is greater than or equal to the preset amount, wherein the reservation information includes the reserved information and the unreserved information.

Optionally, the server is further configured to acquire conference update reservation information for the target conference room at a second predetermined moment;

the server is further configured to generate first update display information based on the conference update reservation information, and send display information that is in the first update display information and different from the first target display information in the case that a total information amount of the first update display information is greater than or equal to the preset amount, wherein

the first target display information includes the preset amount of reservation information arranged in chronological order of reserved periods.

Optionally, the display screen of the conference doorplate is an electronic ink screen.

Optionally, the server is further configured to provide at least one of the following call interfaces:

a first call interface configured to change the target doorplate identifier of the conference doorplate and a second call interface configured to search for the target doorplate identifier of the conference doorplate.

According to another aspect of the present disclosure, a conference doorplate is provided. The conference doorplate includes a display screen, and the conference doorplate is configured to receive to-be-displayed information of a target conference room and display the to-be-displayed information via the display screen; and

update the to-be-displayed information after receiving a task update instruction of the target conference room, wherein the to-be-displayed information includes first display information or second display information.

Optionally, in the case that the conference reservation information has content, the to-be-displayed information includes the first display information, wherein the first display information is generated based on a first preset display template;

the first display information includes reserved information and unreserved information that correspond to the target conference room, or the first display information includes reserved information corresponding to the target conference room, wherein

the reserved information includes at least one of the following: a reserved period, a booking person, a piece of contact information, and a reserved state; and the unreserved information includes an idle period and an idle state; or

in the case that the conference reservation information does not have content, the to-be-displayed information includes the second display information, wherein the second display information is generated based on a second preset type display template; and

the display screen is an electronic ink screen.

Optionally, the display screen of the conference doorplate displays a conference reservation code, wherein the conference reservation code includes at least one of a two-dimensional code and a conference room electronic tag; and

the conference reservation code is configured to jump to a first conference reservation page of the system for managing the conference doorplate as defined in the above aspect; or

the conference reservation code is configured to jump to a second conference reservation page of a third-party conference reservation system.

According to still another aspect of the present disclosure, a method for managing a conference doorplate is provided. The method is applicable to a system for managing a conference doorplate including a server, as well as a wireless refresh device and a conference doorplate that are connected to the server, wherein the conference doorplate includes a display screen, a signal range of the wireless refresh device covering the conference doorplate; and

the method includes:

regularly acquiring conference reservation information for a target conference room by the server and generating to-be-displayed information of the conference doorplate by the server based on the conference reservation information;

sending the to-be-displayed information and a target doorplate identifier of the conference doorplate to the wireless refresh device by the server;

sending the to-be-displayed information to the conference doorplate by the wireless refresh device based on the target doorplate identifier;

displaying the to-be-displayed information by the conference doorplate via the screen;

sending a task update instruction for the target conference room and the target doorplate identifier to the wireless refresh device by the server after the server receives the task update instruction;

sending the task update instruction to the conference doorplate by the wireless refresh device based on the target doorplate identifier; and

updating the to-be-displayed information by the conference doorplate based on the task update instruction.

Optionally, the display screen of the conference doorplate displays a conference reservation code, wherein the conference reservation code includes at least one of a two-dimensional code and a conference room electronic tag; and

regularly acquiring the conference reservation information for the target conference room by the server includes:

receiving, in the case that the conference reservation code is configured to jump to a first conference reservation page of the system for managing the conference doorplate, a conference reservation message for the target conference room by the server based on the conference reservation code; or

receiving, in the case that the conference reservation code is configured to jump to a second conference reservation page of a third-party conference reservation system, a conference reservation message sent by the third-party conference reservation system by the server, after the third-party conference reservation system receives a reservation instruction for the target conference room in the second conference reservation page based on the conference reservation code and generates the conference reservation message based on the reservation instruction for the target conference room.

Optionally, the to-be-displayed information includes first display information or second display information; and generating the to-be-displayed information of the conference doorplate based on the conference reservation information includes:

generating, in the case that the conference reservation information has content, first display information of the conference doorplate by the server based on the conference reservation information and a first preset type display template; or

generating, in the case that the conference reservation information does not have content, second display information of the conference doorplate by the server based on a second preset type display template.

Optionally, sending the to-be-displayed information to the wireless refresh device by the server in the case that the first display information includes reserved information and unreserved information that correspond to the target conference room includes:

determining a total information amount of the reserved information and the unreserved information in the first display information; sending, in the case that the total information amount is greater than or equal to the preset amount, first target display information including a preset amount of reservation information at a first predetermined moment; acquiring conference update reservation information for the target conference room at a second predetermined moment; generating first update display information based on the conference update reservation information; and send, in the case that a total information amount of the first update display information is greater than or equal to the preset amount, display information that is in the first update display information and different from the first target display information, wherein the reservation information includes the reserved information and the unreserved information, and the first target display information includes the preset amount of reservation information arranged in chronological order of reserved periods.

Optionally, the system for managing the conference doorplate further includes a conference management client being connected to the server; and the method further includes:

receiving a management instruction for the target conference room by the conference management client, acquiring an information processing result by processing conference room doorplate information of the target conference room by the conference management client based on the management instruction, and sending the information processing result to the server by the conference management client; and

updating the conference room doorplate information of the target conference room by the server based on the information processing result, wherein

in the case that the management instruction includes a binding instruction, the conference management client binds, based on the binding instruction, the target conference room to the target doorplate identifier of the conference doorplate set for the target conference room;

in the case that the management instruction includes a doorplate information update instruction, the conference management client updates doorplate information of the conference doorplate based on the doorplate information update instruction;

in the case that the management instruction includes a doorplate information searching instruction, the conference management client displays the doorplate information of the conference doorplate based on the doorplate information searching instruction; and

in the case that the management instruction includes a doorplate template setting instruction, the conference management client sets a display template of the conference doorplate based on the doorplate template setting instruction, wherein

the doorplate information includes at least one of the target doorplate identifier and a doorplate size.

### BRIEF DESCRIPTION OF THE DRAWINGS

To describe the technical solutions in embodiments of the present disclosure more clearly, the following briefly describes the accompanying drawings required for describing the embodiments and the related art. Apparently, the accompanying drawings in the following description show merely some embodiments of the present disclosure, and other drawings may be derived from these accompanying drawings.

FIG. 1 is a schematic structural diagram of a system for managing a conference doorplate according to an embodiment of the present disclosure;

FIG. 2 is a schematic diagram of interaction between a system for managing a conference doorplate and a third-party conference reservation system according to an embodiment of the present disclosure;

FIG. 3 is a schematic diagram of an interface of a conference reservation page according to an embodiment of the present disclosure;

FIG. 4 is a diagram of an interface displaying first display information according to an embodiment of the present disclosure;

FIG. 5 is a diagram of an interface displaying second display information according to an embodiment of the present disclosure;

FIG. 6 is a schematic structural diagram of another system for managing a conference doorplate according to an embodiment of the present disclosure; and

FIG. 7 is a schematic flowchart of a method for managing a conference doorplate according to an embodiment of the present disclosure.

### DETAILED DESCRIPTION

To help a person skilled in the art better understand the solutions of the present disclosure, the following describes the technical solutions in the embodiments of the present disclosure with reference to the accompanying drawings in the embodiments of the present disclosure. Apparently, the described embodiments are merely some but not all of the embodiments of the present disclosure. All embodiments obtained based on the present disclosure shall fall within the protection scope of the present disclosure.

First, an application scenario of the present disclosure is described. The present disclosure may be applied to a conference reservation scenario. In this scenario, a user may view conference reservation status of a conference room via a conference doorplate at a door of the conference room, so as to make a reservation for the conference room based on the conference reservation status. For example, a user may view reserved periods of the conference room; determine idle periods based on the reserved periods; and select a period meeting user's needs from the idle periods, to make a reservation.

The following describes the present disclosure in detail with reference to specific embodiments.

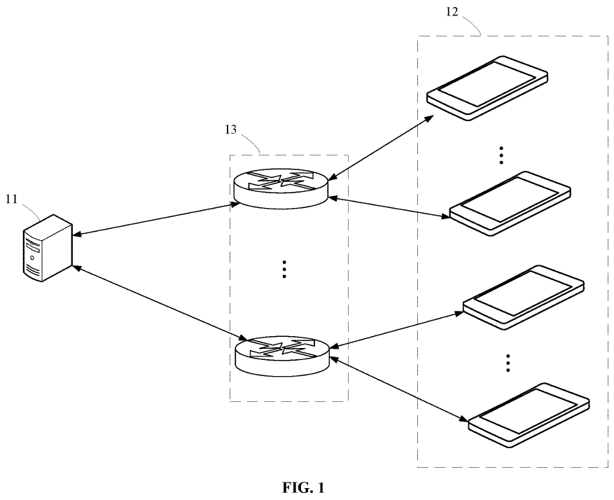

FIG. 1 shows a system for managing a conference doorplate according to an embodiment of the present disclosure. As shown in FIG. 1, the system for managing the conference doorplate includes a server 11 and a conference doorplate 12. The conference doorplate 12 includes a display screen and may correspond to the server 11.

It may be understood that, the server 11 is configured to regularly acquire conference reservation information for a target conference room; generate to-be-displayed information based on the conference reservation information; send the to-be-displayed information; and send a task update instruction for the target conference room after receiving the task update instruction, wherein the task update instruction is configured to update the to-be-displayed information.

The conference doorplate 12 is configured to receive and display the to-be-displayed information.

The conference doorplate 12 is further configured to receive the task update instruction and update the to-be-displayed information based on the task update instruction.

In summary, according to the system for managing the conference doorplate provided in this embodiment of the present disclosure, the server regularly sends the to-be-displayed information to the conference doorplate and updates the to-be-displayed information of the conference doorplate to manage the conference doorplate. While regularly acquiring the conference reservation information, the server may also receive the task update instruction for the target conference room in the case that the conference reservation information for the target conference room changes; and send the task update instruction, such that the conference doorplate updates the to-be-displayed information based on the task update instruction. In this way, the server does not need to generate to-be-displayed information in real-time, thereby reducing an amount of to-be-processed information.

Optionally, the server 11 is further configured to provide at least one of the following call interfaces:

a first call interface configured to change a target doorplate identifier of the conference doorplate 12 and a second call interface configured to search for the target doorplate identifier of the conference doorplate 12.

Optionally, the to-be-displayed information includes first display information or second display information. The server 11 is further configured to determine an information type of the conference reservation information; and in the case that the information type indicates that reservation information is available, generate the first display information of the conference doorplate 12 based on the conference reservation information and a first preset type display template; and in the case that the information type indicates that the reservation information is unavailable, generate the second display information of the conference doorplate 12 based on a second preset type display template.

Optionally, the display screen of the conference doorplate 12 is an electronic ink screen. Thus, the conference doorplate 12 may be an electronic ink conference doorplate.

Optionally, the conference doorplate 12 may be hung on a door of the target conference room by a supporting part, or a front wall of the target conference room by the supporting part, such that a user can conveniently view the reservation status. Exemplarily, a size of the conference doorplate 12 in the present disclosure may be 12.2 inches, and the size of the conference doorplate 12 may be another value, for example, the size may be selected appropriately based on decoration, a layout, and a size of the target conference room.

In an embodiment, each conference room may be provided with one or more conference doorplates; in another embodiment, to reduce a cost, several adjacent conference rooms may share one conference doorplate, which is not limited in the present disclosure.

Optionally, the server 11 may send data to the conference doorplate 12 directly or indirectly via another device. In an optional embodiment of the present disclosure, as shown in FIG. 1, the system for managing the conference doorplate further includes a wireless refresh device 13. The wireless refresh device 13 may establish a wireless connection to the server 11, and a signal range of the wireless refresh device 13 covers the conference doorplate 12.

Optionally, the server 11 is further configured to send a target doorplate identifier to the wireless refresh device 13. The wireless refresh device 13 is configured to receive the to-be-displayed information and the target doorplate identifier that are sent by the server 11, send the to-be-displayed information based on the target doorplate identifier, and send a task update instruction after receiving the task update instruction sent by the server. In this case, the conference doorplate 12 is configured to receive the to-be-displayed information sent by the wireless refresh device 13, display the to-be-displayed information, and update the to-be-displayed information after receiving the task update instruction.

In this embodiment of the present disclosure, the wireless refresh device may cover conference doorplates provided for a plurality of conference rooms, and then the server may determine, based on the target doorplate identifier, a conference doorplate to which information needs to be sent; and send the to-be-displayed information to the determined conference doorplate, thereby improving the accuracy of information transmission.

The wireless refresh device uses a specific protocol to send the to-be-displayed information to the conference doorplate. The specific protocol may be a Bluetooth proprietary protocol or 2.4 GHz proprietary protocol, and the specific protocol may be another protocol that can ensure the security of information transmission, which is not limited in the present disclosure.

The server may acquire the conference reservation information of the target conference room by, but not limited to the following modes:

Mode I: The conference doorplate 12 displays a conference reservation code, wherein the conference reservation code includes at least one of a two-dimensional code and a conference room electronic tag. In the case that the conference reservation code is configured to jump to a first conference reservation page of the system for managing the conference doorplate, the server is further configured to receive a conference reservation message for the target conference room based on the conference reservation code. The conference reservation information may include at least one of a reserved period, a booking person, a piece of contact information, and the target doorplate identifier (such as a doorplate number or a conference room name) of the target conference room.

Optionally, the server may store conference reservation information for different conference rooms separately, such that the server may quickly read conference reservation information for the target conference room that needs to be used.

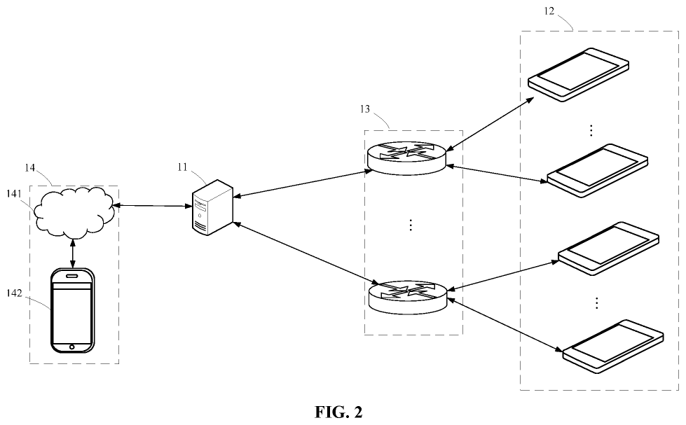

Mode II: The system for managing the conference doorplate in the present disclosure may be interconnected to a third-party conference reservation system, thereby having compatibility. FIG. 2 is a schematic diagram of interaction between a system for managing a conference doorplate and a third-party conference reservation system 14. The third-party conference reservation system 14 may include a conference reservation system 141 and a user device 142. The server 11 of the system for managing the conference doorplate may be connected to the third-party conference reservation system 14. Optionally, in an optional embodiment, a user may perform conference reservation on the user device 142 via a network; then, the user device 142 generates conference reservation information based on the conference reservation of the user, and sends the conference reservation information to the conference reservation system 141; and the conference reservation system 141 sends the conference reservation information to the server 11, such that the server 11 may store the conference reservation information. In another optional embodiment, the conference doorplate 12 displays a conference reservation code. The conference reservation code includes at least one of a two-dimensional code and a conference room electronic tag. In the case that the conference reservation code is configured to jump to a second conference reservation page of a third-party conference reservation system, the server is further configured to receive a conference reservation message sent by the third-party conference reservation system, after the third-party conference reservation system receives a reservation instruction for the target conference room in the second conference reservation page based on the conference reservation code and generates the conference reservation message based on the reservation instruction for the target conference room.

In summary, the conference reservation information for the target conference room in the present disclosure may be the conference reservation information sent by the third-party conference reservation system 14.

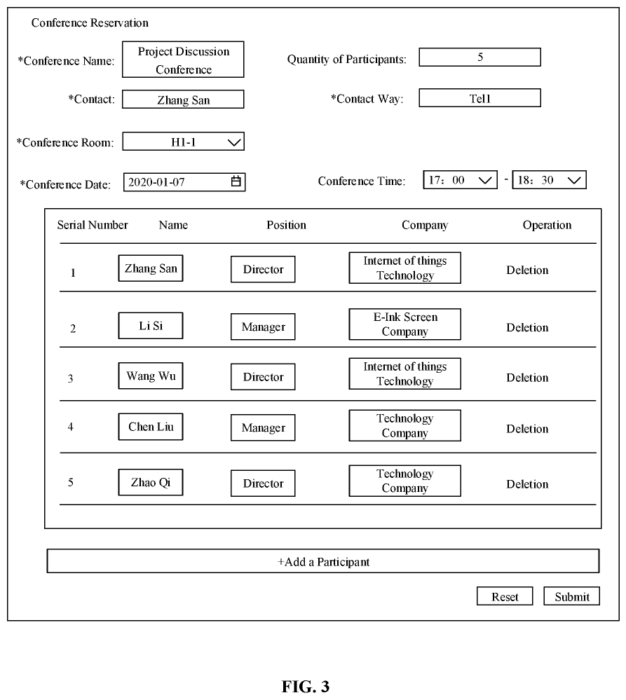

Exemplarily, FIG. 3 shows a diagram of an interface of a conference reservation page. The conference reservation page may be the first conference reservation page or the second conference reservation page. The conference reservation page may have functions of selecting a conference name, a quantity of participants, a contact, a piece of contact information, a conference room, a conference date, conference time, a participant, and the like. In addition, functions may be added or deleted according to actual needs.

It should be understood that the first call interface and the second call interface in the present disclosure may be understood as application programming interfaces (API).

Optionally, changing a doorplate identifier of a conference doorplate may be understood as adding, or deleting, or changing a doorplate identifier, or the like. In this way, in the case that a new conference doorplate is mounted, a doorplate identifier of the new conference doorplate is added; in the case that a conference doorplate is removed, a doorplate identifier of the conference doorplate is deleted; and in the case that a conference doorplate is removed from a first conference room and mounted to a second conference room, the doorplate identifier of the conference doorplate is changed accordingly. It can be seen that in the case that a conference doorplate changes, the doorplate identifier of the conference doorplate may be changed via the first call interface.

In addition, conference reservation information for the conference room may change. For example, a user may have reserved a first period of a first conference room, but need to reserve a second period of the first conference room instead of the first period of the first conference room because of an unforeseen circumstance, such that a reserved period of the first conference room needs to be changed. For another example, the user may have reserved the first period of the first conference room, but casually need to reserve a second period of a second conference room instead of the first period of the first conference room, such that reservation information of the first period of the first conference room is deleted, and reservation information of the second period of the second conference room is added. For still another example, in the case that the user needs to casually reserve a third period of the target conference room, conference update reservation information is generated based on conference reservation performed by the user and is added to the to-be-displayed information. For yet another example, in the case that the user needs to casually cancel reservation of a fourth period of the target conference room, corresponding conference reservation information is deleted from the to-be-displayed information based on conference cancellation performed by the user.

In summary, the server can accurately display reservation status of the target conference room while regularly acquiring the conference reservation information. In addition, the server can also receive the task update instruction for the target conference room in the case that the conference reservation information for the target conference room changes; and send the task update instruction, such that the conference doorplate updates the to-be-displayed information based on the task update instruction. In this way, the server does not need to generate to-be-displayed information in real-time, which reduces an amount of to-be-processed information.

Generally, it is considered that there are two conference reservation cases for the target conference room: one is that at least one period of the target conference room is reserved, and the other is that the target conference room is not reserved. In the present disclosure, different pieces of to-be-displayed information are generated for different cases. Therefore, in the case that at least one period of the target conference room is reserved, a user may view idle periods based on the to-be-displayed information; and in the case that the target conference room is not reserved, the to-be-displayed information may prompt the user to reserve the target conference room. For example, the to-be-displayed information may display text information with “Welcome to make a reservation”, information related to enterprise culture, and the like.

Optionally, the to-be-displayed information may include first display information or second display information. In this case, the server is further configured to determine an information type of the conference reservation information. In addition, in the case that the information type indicates that reservation information is available, the server generates the first display information of the conference doorplate based on the conference reservation information and a first preset type display template; and in the case that the information type indicates that the reservation information is unavailable, the server generates the second display information of the conference doorplate based on a second preset type display template. In other words, the server may be configured to generate the first display information based on the conference reservation information and the first preset type display template, and determine the first display information as the to-be-displayed information in the case that the conference reservation information has content; and generate second display information based on a second preset type display template and determine the second display information as the to-be-displayed information in the case that the conference reservation information does not have content.

Optionally, in the case that the information type indicates that the reservation information is available, the first preset type display template corresponding to the conference reservation information is available, and the conference reservation information may be added to the first preset type display template to acquire the first display information; and in the case that the information type indicates that the reservation information is unavailable, as a second preset type display template corresponding to non-existing conference reservation information is preset, the second preset type display template is used as the second display information, or the target doorplate identifier of the target conference room is added to the second preset type display template to acquire the second display information.

In this way, the server may push different forms of conference reservation information to the conference doorplate based on whether the conference reservation information has content, such that the conference doorplate can accurately display the reservation information.

In the case that the information type indicates that the reservation information is available (that is, the conference reservation information has content), the target conference room may be reserved for all periods or some periods. Therefore, in the case that the target conference room is reserved for some periods, the first display information may include reserved information and unreserved information that correspond to the target conference room; or in the case that the target conference room is reserved for all periods, the first display information may include the reserved information corresponding to the target conference room.

Optionally, the reserved information includes at least one of the following: a reserved period, a booking person, a piece of contact information, and a reserved state; and the unreserved information includes an idle period and an idle state. In this way, the user can view status of various reservations for the target conference room on a current day based on the first display information.

It should be understood that in the case that the first display information includes the reserved information and the unreserved information that correspond to the target conference room, to clearly differentiate between the reserved information and the unreserved information, the conference doorplate may be configured to display the reserved information and the unreserved information in different display styles.

For example, the display styles may be font colors. For example, the reserved information may be displayed in a first font color (such as black or blue); and the unreserved information may be displayed in a second font color (such as red or purple).

For another example, the display styles may be a bold font and a non-bold font. For example; the reserved information may be displayed in the non-bold font; and the unreserved information may be displayed in the bold font.

For still another example; the display styles may be an italic font and a non-italic font. For example, the reserved information may be displayed in the non-italic font; and the unreserved information may be displayed in the italic font.

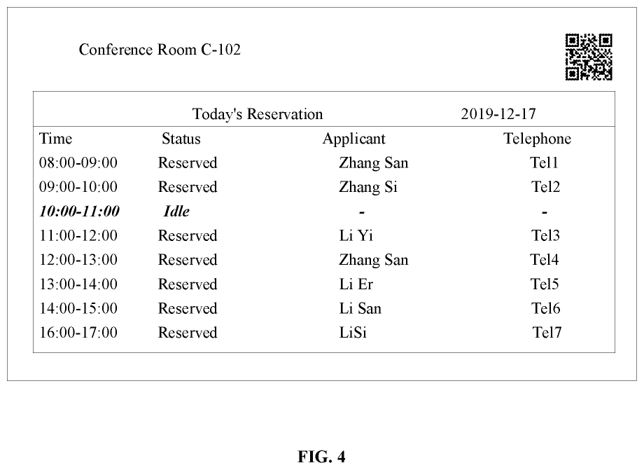

The foregoing examples are illustrative only. In addition, the display styles in the present disclosure may be of a plurality of types, Exemplarily, FIG. 4 shows a diagram of an interface displaying first display information. As shown in FIG. 4, the reserved information is displayed in a non-italic and non-bold font; and the unreserved information is displayed in an italic and bold font. In this way, a user can quickly identify to-be-viewed information based on different display styles.

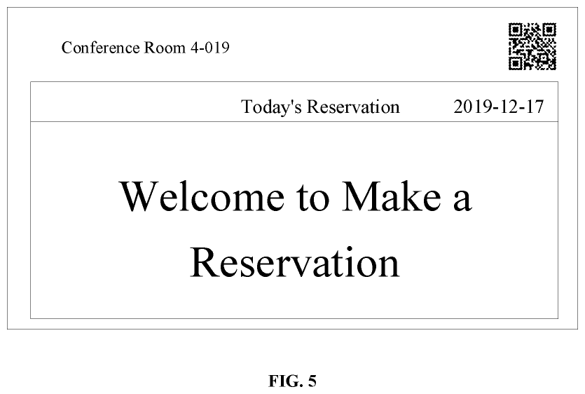

FIG. 5 shows a diagram of an interface displaying second display information. As shown in FIG. 5, the display interface may display an English doorplate number, a date, and text “Welcome to make a reservation”. In this way, the user can determine that the target conference room is not reserved currently in the case that seeing the display interface shown in FIG. 5.

In addition, in the case that the first display information includes the reserved information and the unreserved information that correspond to the target conference room, the server is further configured to determine a total information amount of the reserved information and the unreserved information that are included in the first display information; in the case that the total information amount is greater than or equal to a preset amount, send first target display information with earlier reserved periods at a first predetermined moment (the first target display information with the earlier reserved periods may include the preset amount of reservation information arranged in chronological order of reserved periods); acquire conference update reservation information for the target conference room at a second predetermined moment; generate first update display information based on the conference update reservation information; and in the case that a total information amount of the first update display information is greater than or equal to the preset amount, send display information that is in the first update display information and different from the first target display information.

In this embodiment of the present disclosure, the display screen of the conference doorplate may be an electronic ink screen. It may be understood that refresh frequency of the electronic ink screen is low, and an amount of information that is displayed by the electronic ink screen is limited, that is, a maximum amount (the foregoing preset amount) of information that is displayed by the electronic ink screen can be determined based on a size of the electronic ink screen (or the conference doorplate), and display duration between the first predetermined moment and the second predetermined moment is determined based on the refresh frequency. In summary, the present disclosure can display a certain amount of information within the display duration. Optionally, the display duration is greater than or equal to 30 minutes.

Exemplarily, in the case that, the maximum information amount is 10, and the total information amount of the reserved information and the unreserved information that are included in the first display information is n. In the case that n≤10, n pieces of information may be displayed in the morning. In the case that n>10, 10 pieces of information with earlier reserved periods may be displayed in the morning. Then, the first update display information may be acquired at 13:00, wherein a total information amount of the first update display information is m. In the case that m>10, the rest (m−10) pieces of information are displayed, wherein the (m−10) pieces of information are in the first update display information and different from the 10 pieces of information displayed in the morning. Both n and m are positive integers; such that the user can view complete information. The foregoing examples are illustrative only, and the present disclosure is not limited thereto.

It should be noted that display templates (the first preset type display template and the second preset type display template) in the present disclosure specify content in each field. Therefore, in the case that the conference reservation information is received, to-be-displayed information in a specified image form may be generated based on the display template. The specified image form includes at least one of a specified resolution and a specified image format, and the to-be-displayed information may be an image.

In summary, according to the system for managing the conference doorplate provided in this embodiment of the present disclosure, the server regularly sends the to-be-displayed information to the conference doorplate, and updates the to-be-displayed information of the conference doorplate, so as to manage the conference doorplate. While regularly acquiring the conference reservation information, the server may also receive the task update instruction for the target conference room in the case that the conference reservation information for the target conference room changes; and send the task update instruction, such that the conference doorplate updates the to-be-displayed information based on the task update instruction. In this way, the server does not need to generate to-be-displayed information in real-time, which reduces an amount of to-be-processed information.

In addition, because power consumption of the electronic ink screen is low, the system for managing the conference doorplate has effects of reducing power consumption and saving energy; and a cost of the system for managing the conference doorplate is low. It may be understood that the electronic ink screen has the characteristics of low power consumption, long service life of battery, and no need of connecting power supply, and in an application scenario where display pictures of a conference room doorplate need not to be refreshed frequently, the present disclosure uses an electronic ink conference doorplate to replace a liquid crystal display, thereby achieving effects of wiring elimination, low cost, and ultra-low power consumption.

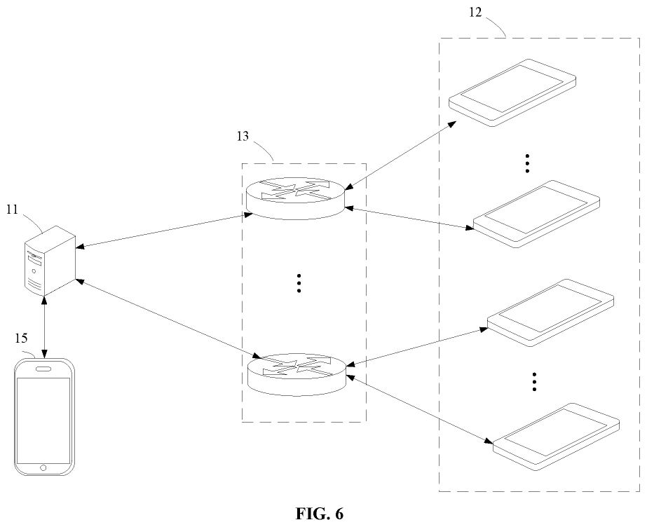

FIG. 6 shows another system for managing a conference doorplate based on the embodiment shown in FIG. 1. As shown in FIG. 6, the system for managing the conference doorplate further includes:

a conference management client 15, wherein the conference management client 15 is connected to the server 11.

It may be understood that the conference management client 15 in the present disclosure may be a World Wide Web page, an application, and the like. The conference management client 15 may be preset in a terminal device, in the conference doorplate 13 in the present disclosure, and the like, which is not limited in the present disclosure.

In this embodiment of the present disclosure, information management is implemented by interface interaction of the conference management client 15. Optionally, the conference management client 15 is configured to perform at least one of the following: binding the target conference room to the target doorplate identifier of the conference doorplate set for the target conference room, updating doorplate information of the conference doorplate; searching for the conference doorplate, and setting a display template of the conference doorplate.

The doorplate information includes at least one of the target doorplate identifier and a doorplate size.

The display template may be the first preset type display template and the second preset type display template in the embodiment shown in FIG. 1.

It should be understood that in the case that the target conference room is bound to the target doorplate identifier, the display information may be accurately pushed to the conference doorplate of the conference room.

In addition, updating the target doorplate identifier of the conference doorplate may be understood as follows: after receiving an information change instruction, updating the target doorplate identifier of the conference doorplate based on the information change instruction. The information change instruction may include a first instruction configured to instruct a user to add a new doorplate identifier, a second instruction configured to instruct the user to delete a first specified doorplate identifier, a third instruction configured to instruct the user to change a second specified doorplate identifier of the conference doorplate, and the like. In this case, in the case that the information change instruction is the first instruction, the new doorplate identifier is added; in the case that the information change instruction is the second instruction, the first specified doorplate identifier is deleted; or in the case that the information change instruction is the third instruction, the second specified doorplate identifier is changed.

In this embodiment of the present disclosure, the user may select a required display template from preset templates stored in the conference management client 15 or may customize a display template in the conference management client 15. In this way, the user may select a display module based on a usage requirement. In addition, after the selection of the display template, in the case that the conference reservation information changes, the display template does not change accordingly, thereby updating the conference reservation information in the display template, and improving generation efficiency of display information, Therefore, user experience and a visual effect can be improved.

In summary, according to the system for managing the conference doorplate provided in this embodiment of the present disclosure, the server regularly sends the tip-be-displayed information to the conference doorplate, and updates the to-be-displayed information of the conference doorplate, so as to manage the conference doorplate. While regularly acquiring the conference reservation information, the server may also receive the task update instruction for the target conference room in the case that the conference reservation information for the target conference room changes; and send the task update instruction, such that the conference doorplate updates the to-be-displayed information based on the task update instruction. In this way, the server does not need to generate to-be-displayed information in real-time, which reduces an amount of to-be-processed information.

In addition, because power consumption of the electronic ink screen is low, the system for managing the conference doorplate has effects of reducing power consumption and saving energy; and a cost of the system for managing a conference doorplate is low. It may be understood that the electronic ink screen has characteristics of low power consumption, long service life of battery, and no need of connecting power supply, and in an application scenario where display pictures of a conference room doorplate need not to be refreshed frequently, the present disclosure uses an electronic ink conference doorplate to replace a liquid crystal display, thereby achieving effects of wiring elimination, low cost, and ultra-low power consumption. According to the system for managing the conference doorplate in this embodiment of the present disclosure, the server manages conference doorplates in a unified mode, and pushes conference reservation information in different pushing modes, such that the conference doorplates can accurately display the reservation information. In addition, the conference management client is provided, thereby managing a doorplate identifier of an electronic ink conference doorplate, and binding the doorplate identifier to a conference room. Therefore, display information can be pushed accurately and information display accuracy is improved.

In an optional embodiment of the present disclosure, a conference doorplate is further provided. The conference doorplate is configured to receive to-be-displayed information of a target conference room; display the to-be-displayed information; and update the to-be-displayed information after receiving a task update instruction for the target conference room, wherein the to-be-displayed information includes first display information or second display information.

It may be understood that in the case that an information type of the to-be-displayed information indicates that reservation information is available (that is, conference reservation information has content), the to-be-displayed information includes the first display information. The first display information is generated based on a first preset display template. The first display information includes reserved information and unreserved information that correspond to the target conference room. Alternatively, the first display information includes the reserved information corresponding to the target conference room. The reserved information includes at least one of the following: a reserved period, a booking person, a piece of contact information, and a reserved state; and the unreserved information includes an idle period and an idle state.

In the case that the information type of the to-be-displayed information indicates that the reservation information is unavailable (that is, the conference reservation information does not have content), the to-be-displayed information includes the second display information. The second display information is generated based on a second preset type display template.

In this embodiment of the present disclosure, the conference doorplate displays a conference reservation code. The conference reservation code includes at least one of a two-dimensional code and a conference room electronic tag. In this case, the conference reservation code is configured to jump to a first conference reservation page of the system for managing the conference doorplate in the embodiment shown in FIG. 1 or FIG. 6, or jump to a second conference reservation page of a third-party conference reservation system, which is not limited in the present disclosure.

It should be noted that in the case that the to-be-displayed information is an image, the conference doorplate may display the to-be-displayed information in a specified image form.

The specific content of the conference doorplate may refer to the content of the embodiment shown in FIG. 1, and details of which are not described herein again.

Compared with a liquid crystal display, the conference doorplate provided in this embodiment of the present disclosure has the advantage that cost is reduced and power consumption and wiring difficulty are reduced.

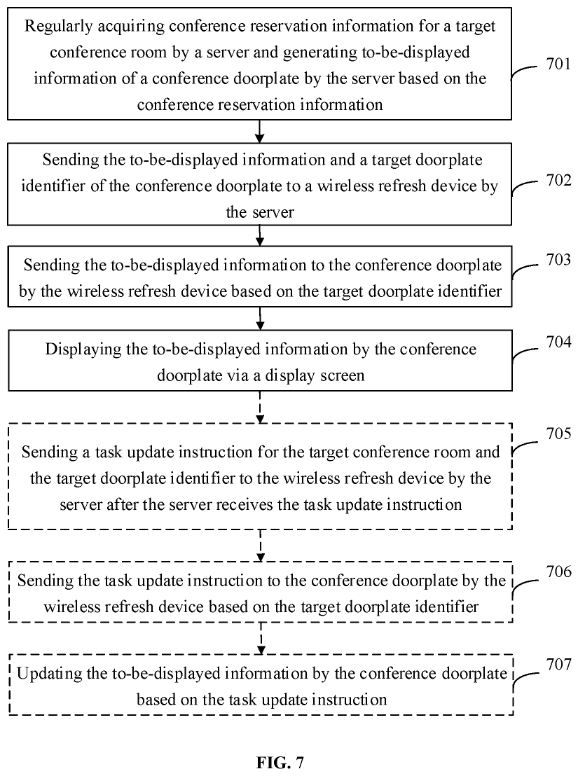

FIG. 7 is a schematic flowchart of a method for managing a conference doorplate according to an embodiment of the present disclosure. As shown in FIG. 7, the method is applicable to a system for managing a conference doorplate. The system for managing the conference doorplate includes a server, as well as a wireless refresh device and a conference doorplate that are connected to the server. A signal range of the wireless refresh device covers the conference doorplate.

The method includes:

In 701, the server regularly acquires conference reservation information for a target conference room and generates to-be-displayed information of a conference doorplate based on the conference reservation information.

In an optional embodiment of the present disclosure, the conference doorplate displays a conference reservation code, wherein the conference reservation code includes at least one of a two-dimensional code and a conference room electronic tag.

In this way, in the case that the conference reservation code is configured to jump to a first conference reservation page of the system for managing the conference doorplate, the server receives a conference reservation message for the target conference room based on the conference reservation code.

Alternatively, in the case that the conference reservation code is configured to jump to a second conference reservation page of a third-party conference reservation system, after the third-party conference reservation system receives, based on the conference reservation code, a reservation instruction for the target conference room that is included in the second conference reservation page, and generates a conference reservation message based on the reservation instruction for the target conference room, the server receives the conference reservation message sent by the third-party conference reservation system.

In addition, in the present disclosure, conference reservations may also be performed via web search in the third-party conference reservation system.

It should be understood that the to-be-displayed information may include first display information or second display information. In this case, generating the to-be-displayed information of the conference doorplate based on the conference reservation information includes:

generating, in the case that the information type indicates that reservation information is available (that is, the conference reservation information has content), first display information of the conference doorplate by the server based on the conference reservation information and a first preset type display template; or generating, in the case that the information type indicates that the reservation information is unavailable (that is, the conference reservation information does not have content), second display information of the conference doorplate by the server based on a second preset type display template.

In 702, the server sends the to-be-displayed information and a target doorplate identifier of the conference doorplate to the wireless refresh device.

In this process, in the case that the first display information includes reserved information and unreserved information that correspond to the target conference room, and sending the to-be-displayed information to the wireless refresh device by the server includes:

determining a total information amount of the reserved information and the unreserved information that are included in the first display information by the server; in the case that the total information amount is greater than or equal to a preset amount, sending first target display information at a first predetermined moment, wherein the first target display information includes the preset amount of reservation information arranged in chronological order of reserved periods; acquiring conference update reservation information for the target conference room at a second predetermined moment; generating first update display information based on the conference update reservation information; and in the case that a total information amount of the first update display information is greater than or equal to the preset amount, sending display information that is in the first update display information and different from the first target di splay information.

It should be noted that in the case that the total information amount is less than or equal to the preset amount, the first display information is sent at the first predetermined moment; the conference update reservation information is acquired at the second predetermined moment; the first update display information is generated based on the conference update reservation information; and the to-be-displayed information is sent based on whether the total information amount of the first update display information is greater than or equal to the preset amount.

Similarly, in the case that the first display information includes the reserved information corresponding to the target conference room, the server determines a total information amount of the reserved information included in the first display information; in the case that the total information amount is greater than or equal to the preset amount, the server sends first target display information with earlier reserved periods at the first predetermined moment; acquires the conference update reservation information for the target conference room at the second predetermined moment; generates the first update display information based on the conference update reservation information; and in the case that the total information amount of the first update display information is greater than or equal to the preset amount, the server sends the display information that is in the first update display information and different from the first target display information.

In 703, the wireless refresh device sends the to-be-displayed information to the conference doorplate based on the target doorplate identifier.

In 704, the conference doorplate displays the to-be-displayed information via a display screen.

Optionally, in this embodiment of the present disclosure, the method may further include the following processes:

In 705, the server sends a task update instruction for the target conference room and the target doorplate identifier to the wireless refresh device after receiving the task update instruction.

In 706, the wireless refresh device sends the task update instruction to the conference doorplate based on the target doorplate identifier.

In 707, the conference doorplate updates the to-be-displayed information based on the task update instruction.

For processes in this embodiment of the present disclosure, reference may also be made to the embodiments shown in FIGS. 1 to 6, and are no longer described herein in this embodiment of the present disclosure.

In an optional embodiment, the system for managing the conference doorplate further includes a conference management client. The conference management client is connected to the server. The method further includes the following.

In 1, the conference management client receives a management instruction for the target conference room, acquires an information processing result by processing conference room doorplate information of the target conference room based on the management instruction, and sends the information processing result to the server.

In 2, the server updates the conference room doorplate information of the target conference room based on the information processing result.

In the case that the management instruction includes a binding instruction, the conference management client binds, based on the binding instruction, the target conference room to the target doorplate identifier of the conference doorplate set for the target conference room.

In the case that the management instruction includes a doorplate information update instruction, the conference management client updates doorplate information of the conference doorplate based on the doorplate information update instruction.

In the case that the management instruction includes a doorplate information searching instruction, the conference management client displays the doorplate information of the conference doorplate based on the doorplate information searching instruction.

In the case that the management instruction includes a doorplate template setting instruction, the conference management client sets a display template of the conference doorplate based on the doorplate template setting instruction.

The doorplate information includes at least one of the target doorplate identifier and a doorplate size.

1 may be performed before 701, after 704, after 707, or the like. This is not limited in the present disclosure.

The specific content of this embodiment of the present disclosure may refer to content of the embodiments shown in FIGS. 1 and 6, and details of which are not described herein again.

In summary, according to the method for managing the conference doorplate provided in this embodiment of the present disclosure, the server regularly sends the to-be-displayed information to the conference doorplate, and updates the to-be-displayed information of the conference doorplate, so as to manage the conference doorplate. While regularly acquiring the conference reservation information, the server may also receive the task update instruction for the target conference room in the case that the conference reservation information for the target conference room changes; and send the task update instruction, such that the conference doorplate updates the to-be-displayed information based on the task update instruction. In this way, the server does not need to generate to-be-displayed information in real-time, which reduces an amount of to-be-processed information.

In addition, because power consumption of the electronic ink screen is low, the system for managing the conference doorplate has effects of reducing power consumption and saving energy; and a cost of the system for managing a conference doorplate is low. It may be understood that the electronic ink screen has characteristics of low power consumption, long service life of battery, and no need of connecting power supply, and in an application scenario where such display pictures of a conference room doorplate need not to be refreshed frequently, the present disclosure uses an electronic ink conference doorplate to replace a liquid crystal display, thereby achieving effects of wiring elimination, low cost, and ultra-low power consumption.

According to the system for managing the conference doorplate in this embodiment of the present disclosure, the server manages conference doorplates in a unified mode, and pushes conference reservation information in different pushing modes, such that the conference doorplates can accurately display the reservation information. In addition, the conference management client is provided, thereby managing a doorplate identifier of a conference doorplate, and binding the doorplate identifier to a conference room. Therefore, display information can be pushed accurately, and information display accuracy can be improved.

In the present disclosure, the term “at least one of A and B” is merely an association relationship that describes associated objects and represents that there may be three relationships. For example, “at least one of A and B” may represent three cases: only A exists, both A and B exist, and only B exists. Similarly, “at least one of A, B, and C” represents that there may be seven relationships: only A exists, only B exists, only C exists, both A and B exist, both A and C exist, both C and B exist, and all of A, B and C exist. Similarly, “at least one of A, B, C and D” represents that there may be fifteen relationships: only A exists, only B exists, only C exists, only D exists, both A and B exist, both A and C exist, both A and D exist, both C and B exist, both D and B exist, both C and D exist, all of A, B and C exist, all of A, B and D exist, all of A, C and D exist, all of B, C and D exist, and all of A, B, C and D exist.

It may be clearly understood by a person skilled in the art that, for convenient and brief description, for a detailed operating process of the foregoing system, apparatus, and unit, refer to a corresponding process in the foregoing method embodiments. Details are not described herein again.

In the several embodiments provided in the present disclosure, it should be understood that the disclosed system, apparatus, and method may be implemented in other manners. For example, the described apparatus embodiment is merely an example. For example, the unit division is merely a logical function division and may be another division in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one location, or may be distributed on a plurality of network units. Some or all of the units may be selected based on actual requirements to achieve the objectives of the solutions of the embodiments.

In addition, functional units in each embodiment of the present disclosure may be integrated into one processing unit, or each unit may have a separate physical existence or two or more units may be integrated into one unit. The integrated units may be implemented in a form of hardware or a form of software function units.

In the case that the integrated units are implemented in the form of software function units and sold or used as independent products, the integrated units may be stored in a computer-readable storage medium. Based on such an understanding, the technical solutions of the present disclosure essentially, or the part contributing to the prior art, or all or some of the technical solutions may be implemented in a form of a software product. The computer software product is stored in a storage medium and includes a plurality of instructions for instructing a computer device (which may be a personal computer, a server, a network device, or the like) to perform all or some of the processes of the methods in the embodiments of the present disclosure. The foregoing storage medium includes any medium that can store program code, such as a USB flash drive, a removable hard disk, a read-only memory (ROM), a random access memory (RAM), a magnetic disk, or an optical disc.

In summary, it should be noted that the foregoing embodiments are merely used to describe the technical solutions of the present disclosure, but are not limitations thereon. Although the present disclosure is described in detail with reference to the foregoing embodiments, a person of ordinary skill in the art should understand that the technical solutions recorded in the foregoing embodiments may still be modified, or that some technical features may be equivalently replaced. However, these modifications or replacements do not make the essence of the corresponding technical solutions go beyond the spirit and scope of the technical solutions of the embodiments of the present disclosure.

1. A system for managing a conference doorplate, comprising a server and a conference doorplate, the conference doorplate comprising a display screen; wherein
the server is configured to regularly acquire conference reservation information for a target conference room, generate to-be-displayed information based on the conference reservation information; send the to-be-displayed information, and send a task update instruction for the target conference room after receiving the task update instruction, wherein the task update instruction is configured to update the to-be-displayed information;
the conference doorplate is configured to receive the to-be-displayed information and display the to-be-displayed information via the screen; and
the conference doorplate is further configured to receive the task update instruction and update the to-be-displayed information based on the task update instruction.

2. The system according to claim 1, further comprising a wireless refresh device, wherein the wireless refresh device is connected to the server and a signal range of the wireless refresh device covers the conference doorplate;
the server is further configured to send a target doorplate identifier to the wireless refresh device; and
the wireless refresh device is configured to receive the to-be-displayed information and the target doorplate identifier that are sent by the server, send the to-be-displayed information based on the target doorplate identifier, and send a task update instruction after receiving the task update instruction sent by the server.

3. The system according to claim 2, wherein
the conference doorplate is further configured to receive the to-be-displayed information sent by the wireless refresh device; display the to-be-displayed information, and update the to-be-displayed information after receiving the task update instruction sent by the wireless refresh device.

4. The system according to claim 3, further comprising a conference management client, wherein the conference management client is connected to the server;
the conference management client is configured to perform at least one of the following: binding the target conference room to the target doorplate identifier of the conference doorplate, updating doorplate information of the conference doorplate; searching for the conference doorplate, and setting a display template of the conference doorplate; and
the doorplate information comprises at least one of the target doorplate identifier and a doorplate size.

5. The system according to claim 4, wherein the display screen of the conference doorplate displays a conference reservation code, wherein the conference reservation code comprises at least one of a two-dimensional code and a conference room electronic tag; and
in the case that the conference reservation code is configured to jump to a first conference reservation page of the system for managing the conference doorplate, the server is further configured to receive a conference reservation message for the target conference room based on the conference reservation code.

6. The system according to claim 4, wherein the display screen of the conference doorplate displays a conference reservation code, wherein the conference reservation code comprises at least one of a two-dimensional code and a conference room electronic tag; and
in the case that the conference reservation code is configured to jump to a second conference reservation page of a third-party conference reservation system, the server is further configured to receive a conference reservation message sent by the third-party conference reservation system, after the third-party conference reservation system receives a reservation instruction for the target conference room in the second conference reservation page based on the conference reservation code and generates the conference reservation message based on the reservation instruction for the target conference room.

7. The system according to claim 1, wherein the server is further configured to generate first display information based on the conference reservation information and a first preset type display template and determine the first display information as the to-be-displayed information in the case that the conference reservation information has content; and
generate second display information based on a second preset type display template and determine the second display information as the to-be-displayed information in the case that the conference reservation information does not have content.

8. The system according to claim 7, wherein in the case that the conference reservation information has the content:
the first display information comprises reserved information and unreserved information that correspond to the target conference room, or the first display information comprises reserved information corresponding to the target conference room, wherein
the reserved information comprises at least one of the following: a reserved period, a booking person, a piece of contact information, and a reserved state; and
the unreserved information comprises an idle period and an idle state.

9. The system according to claim 8, wherein in the case that the first display information comprises reserved information and unreserved information that correspond to the target conference room, the server is further configured to determine a total information amount of the reserved information and the unreserved information in the first display information; and
the server is further configured to send first target display information comprising a preset amount of reservation information at a first predetermined moment in the case that the total information amount is greater than or equal to the preset amount, wherein the reservation information comprises the reserved information and the unreserved information.

10. The system according to claim 9, wherein the server is further configured to acquire conference update reservation information for the target conference room at a second predetermined moment;
the server is further configured to generate first update display information based on the conference update reservation information, and send display information that is in the first update display information and different from the first target display information in the case that a total information amount of the first update display information is greater than or equal to the preset amount, wherein
the first target display information comprises the preset amount of reservation information arranged in chronological order of reserved periods.

11. The system according to claim 1, wherein the display screen of the conference doorplate is an electronic ink screen.

12. The system according to claim 1, wherein the server is further configured to provide at least one of the following call interfaces:
a first call interface configured to change the target doorplate identifier of the conference doorplate and a second call interface configured to search for the target doorplate identifier of the conference doorplate.

13. A conference doorplate, wherein the conference doorplate comprises a display screen, and the conference doorplate is configured to receive to-be-displayed information of a target conference room and display the to-be-displayed information via the display screen; and
update the to-be-displayed information after receiving a task update instruction for the target conference room, wherein the to-be-displayed information comprises first display information or second display information.

14. The conference doorplate according to claim 13, wherein in the case that the conference reservation information has content, the to-be-displayed information comprises the first display information, wherein the first display information is generated based on a first preset display template;
the first display information comprises reserved information and unreserved information that correspond to the target conference room, or the first display information comprises reserved information corresponding to the target conference room, wherein
the reserved information comprises at least one of the following: a reserved period, a booking person, a piece of contact information, and a reserved state; and the unreserved information comprises an idle period and an idle state; or
in the case that the conference reservation information does not have content, the to-be-displayed information comprises the second display information, wherein the second display information is generated based on a second preset type display template; and
the display screen is an electronic ink screen.

15. The conference doorplate according to claim 14, wherein the display screen of the conference doorplate displays a conference reservation code, wherein the conference reservation code comprises at least one of a two-dimensional code and a conference room electronic tag; and
the conference reservation code is configured to jump to a first conference reservation page of the system for managing the conference doorplate as defined in claim 1; or
the conference reservation code is configured to jump to a second conference reservation page of a third-party conference reservation system.

16. A method for managing a conference doorplate, wherein the method is applicable to a system for managing a conference doorplate comprising a server, as well as a wireless refresh device and a conference doorplate that are connected to the server, wherein the conference doorplate comprises a display screen, a signal range of the wireless refresh device covering the conference doorplate; and
the method comprises:
regularly acquiring conference reservation information for a target conference room by the server and generating to-be-displayed information of the conference doorplate by the server based on the conference reservation information;
sending the to-be-displayed information and a target doorplate identifier of the conference doorplate to the wireless refresh device by the server;
sending the to-be-displayed information to the conference doorplate by the wireless refresh device based on the target doorplate identifier;
displaying the to-be-displayed information by the conference doorplate via the screen;
sending a task update instruction for the target conference room and the target doorplate identifier to the wireless refresh device by the server after the server receives the task update instruction;
sending the task update instruction to the conference doorplate by the wireless refresh device based on the target doorplate identifier; and
updating the to-be-displayed information by the conference doorplate based on the task update instruction.

17. The method according to claim 16, wherein the display screen of the conference doorplate displays a conference reservation code, wherein the conference reservation code comprises at least one of a two-dimensional code and a conference room electronic tag; and
regularly acquiring the conference reservation information for the target conference room by the server comprises:
receiving, in the case that the conference reservation code is configured to jump to a first conference reservation page of the system for managing the conference doorplate, a conference reservation message for the target conference room by the server based on the conference reservation code; or
receiving, in the case that the conference reservation code is configured to jump to a second conference reservation page of a third-party conference reservation system, a conference reservation message sent by the third-party conference reservation system by the server, after the third-party conference reservation system receives a reservation instruction for the target conference room in the second conference reservation page based on the conference reservation code and generates the conference reservation message based on the reservation instruction for the target conference room.

18. The method according to claim 16, wherein the to-be-displayed information comprises first display information or second display information, and generating the to-be-displayed information of the conference doorplate based on the conference reservation information comprises:
generating, in the case that the conference reservation information has content, first display information of the conference doorplate by the server based on the conference reservation information and a first preset type display template; or
generating, in the case that the conference reservation information does not have content, second display information of the conference doorplate by the server based on a second preset type display template.

19. The method according to claim 18, wherein sending the to-be-displayed information to the wireless refresh device by the server in the case that the first display information comprises reserved information and unreserved information that correspond to the target conference room comprises:
determining a total information amount of the reserved information and the unreserved information in the first display information; sending, in the case that the total information amount is greater than or equal to the preset amount, first target display information comprising a preset amount of reservation information at a first predetermined moment; acquiring conference update reservation information for the target conference room at a second predetermined moment; generating first update display information based on the conference update reservation information; and send, in the case that a total information amount of the first update display information is greater than or equal to the preset amount, display information that is in the first update display information and different from the first target display information, wherein the reservation information comprises the reserved information and the unreserved information, and the first target display information comprises the preset amount of reservation information arranged in chronological order of reserved periods.

20. The method according to claim 16, wherein the system for managing the conference doorplate further comprises a conference management client being connected to the server, and the method further comprises:
receiving a management instruction for the target conference room by the conference management client; acquiring an information processing result by processing conference room doorplate information of the target conference room by the conference management client based on the management instruction; and sending the information processing result to the server by the conference management client; and
updating the conference room doorplate information of the target conference room by the server based on the information processing result; wherein
in the case that the management instruction comprises a binding instruction the conference management client binds, based on the binding instruction, the target conference room to the target doorplate identifier of the conference doorplate set for the target conference room;
in the case that the management instruction comprises a doorplate information update instruction, the conference management client updates doorplate information of the conference doorplate based on the doorplate information update instruction;
in the case that the management instruction comprises a doorplate information searching instruction, the conference management client displays the doorplate information of the conference doorplate based on the doorplate information searching instruction; and
in the case that the management instruction comprises a doorplate template setting instruction, the conference management client sets a display template of the conference doorplate based on the doorplate template setting instruction, wherein
the doorplate information comprises at least one of the target doorplate identifier and a doorplate size.
